(19) United States
(12) Patent Application Publication
(10) Pub. No.: US 2010/0033640 A1
(43) Pub. Date: Feb. 11, 2010

(54) DIGITAL PHOTO FRAME CAPABLE OF ADJUSTING PICTURE PARAMETERS AND METHOD THEREOF

(75) Inventors: MING-FENG TSAI, Tu-Cheng (TW); CHENG-HAO CHOU, Tu-Cheng (TW); KUAN-HONG HSIEH, Tu-Cheng (TW); XIAO-GUANG LI, Shenzhen City (CN); ZAI-AN PAN, Shenzhen City (CN); GUANG-JIN LI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/266,563

(22) Filed: Nov. 7, 2008

(30) Foreign Application Priority Data
Aug. 8, 2008 (CN) 200810303623.0

(51) Int. Cl. H04N 5/66; G09G 5/00

(52) U.S. Cl. 348/836; 345/619; 348/E05.133

(57) ABSTRACT

A method for updating pictures asynchronously is provided. The method comprises: extracting parameter values of a selected picture; defining extracted parameter values as standard parameter values; and adjusting parameter values of other pictures according to the standard parameter values.

### TECHNICAL FIELD

The disclosure relates to a digital photo frame for adjusting picture parameter values and method thereof.

### DESCRIPTION OF RELATED ART

Digital photo frames are configured for displaying digital images without having to print them, thereby playing an important role in our everyday lives. As advances in microprocessor and other technologies continue to improve the performance of various electronic components, digital photo frames become more compact and powerful, thereby gradually replacing traditional picture frames. Therefore, digital photo frames have become increasingly popular in recent years. Digital photo frames adjust picture parameter values in order to display pictures with a better effect. However, it is inconvenient for users to configure each parameter value of each picture in order to obtain a better display effect. Therefore, what is needed is a digital photo frame capable of adjusting picture parameter values easily and method thereof.

### SUMMARY

A digital photo frame for adjusting picture parameter values is provided. The digital photo frame includes a memory and a processor, wherein the memory is configured for storing pictures and parameter values of each of the pictures. The processor is connected with the memory and includes a parameter extracting module, a reading module, and a parameter adjusting module. The reading module is configured for obtaining pictures from the memory. The parameter extracting module is configured for extracting parameter values of a selected picture and defining the extracted parameter values as standard parameter values. The parameter adjusting module is configured for adjusting parameter values of other pictures according to the standard parameter values.

Other advantages and novel features will be drawn from the following detailed description of the preferred embodiment with references to the attached drawings.

### BRIEF DESCRIPTION OF THE DRAWINGS

The components of the drawings are not necessarily drawn to scale, the emphasis instead being placed upon clearly illustrating the principles of a digital photo frame. Moreover, in the drawings, like reference numerals designate corresponding parts throughout several views.

FIG. 1 is a block diagram of a digital photo frame in accordance with an exemplary embodiment.

FIG. 2 is a flowchart for a method of adjusting picture parameter values in accordance with an exemplary embodiment.

### DETAILED DESCRIPTION OF EMBODIMENTS

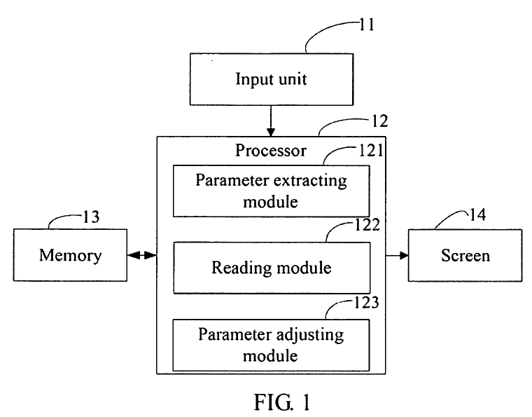

FIG.1 is a block diagram of a hardware infrastructure of a digital photo frame in accordance with an exemplary embodiment. The digital photo frame includes at least one input unit 11, a processor 12, a memory 13, and a screen 14.

The memory 13 is configured for storing pictures and parameter values of each of the pictures. The input unit 11 is configured for selecting pictures. For example, when the screen 14 displays a picture that a user likes, the user can select the picture via the input unit 11. The processor 12 is electrically connected with the input unit 11, the memory 13, and the screen 14. The processor 12 includes a parameter extracting module 121, a reading module 122, and a parameter adjusting module 123. The parameter extracting module 121 is configured for extracting parameter values of a selected picture and defining the extracted parameter values as standard parameter values. The parameter values include, but are not limited to, at least one of a proportion value, a brightness value, a contrast value, a color value, or a display angle value. In addition, if the memory 13 does not store the standard parameter values, the parameter extracting module 121 stores the extracted parameter values in the memory 13 as the standard parameter values. If the standard parameter values exist in the memory 13, the parameter extracting module 121 substitutes the extracted parameter values for the existing standard parameter values. The reading module 122 is configured for obtaining the picture from the memory 13. The parameter adjusting module 123 is configured for adjusting parameter values of other pictures according to the standard parameter values. The other pictures can either be pictures to be displayed or all pictures stored in the memory 13. Therefore, in an exemplary embodiment, the parameter adjusting module 123 adjusts parameter values of the pictures to be displayed automatically according to the standard parameter values. In another exemplary embodiment, the parameter adjusting module 123 adjusts parameter values of all the pictures stored in the memory 13 automatically according to the standard parameter values. When the parameter extracting module 121 extracts new parameter values, the parameter extracting module 121 further generates a prompt to remind the user whether to define the extracted parameter as the standard parameter values. If the parameter extracting module 121 does not receive a response to the prompt in a predetermined time period, the parameter extracting module 121 does not alter the standard parameter values. If the parameter extracting module 121 receives the response in the predetermined time period, the parameter extracting module 121 defines the extracted parameter values as the standard parameter values. The parameter adjusting module 123 adjusts parameter values of other pictures according to the defined standard parameter values.

The digital photo frame further provides a special key for activating the digital photo frame to enter a picture parameter value adjustment mode. The digital photo frame can also provide a menu item for activating the digital photo frame to enter the picture parameter value adjustment mode.

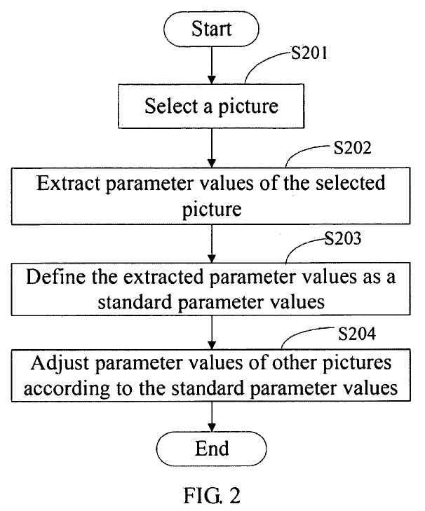

FIG. 2 is a flowchart illustrating a method of adjusting picture parameter values applied in the digital photo frame of FIG. 1 in accordance with an exemplary embodiment.

In step S201, after the digital photo frame enters the picture parameter value adjustment mode though the special key or the menu item, the user selects the picture to be displayed on the screen 14 via the input unit 11.

In step S202, the parameter extracting module 121 extracts the parameter values of the selected picture.

In step S203, the parameter extracting module 121 defines the extracted parameter values as the standard parameter values.

In step S204, the parameter adjusting module 123 adjusts the parameter values of other pictures according to the defined standard parameter values. The other pictures can be pictures to be displayed or all pictures stored in the memory 13.

Furthermore, in step S203, the parameter extracting module 121 can further display the prompt to remind the user whether to define the extracted parameter values as the standard parameter values. If the parameter extracting module 121 receives the response to the prompt, the parameter extracting module 121 defines the extracted parameter values as the standard parameter values. If the parameter extracting module 121 does not receive the response to the prompt, the parameter extracting does not alter the standard parameter values.

Although the present invention has been specifically described on the basis of the exemplary embodiment thereof, the invention is not to be construed as being limited thereto. Various changes or modifications may be made to the embodiment without departing from the scope and spirit of the invention.

What is claimed is:

1. A digital photo frame (DPF) for adjusting picture parameters, comprising:
a memory for storing pictures and parameter values of each of the pictures; and
a processor being connected with the memory, comprising:
a reading module configured for obtaining pictures from the memory; and
a parameter extracting module configured for extracting the parameter values of a selected picture and defining the extracted parameter values as standard parameter values; and
a parameter adjusting module configured for adjusting parameter values of other pictures according to the standard parameter values.

2. The DPF as described in claim 1, wherein other pictures are selected from the group consisting of pictures to be displayed and all pictures stored in the memory.

3. The DPF as described in claim 2, wherein the parameter values comprise at least one of a proportion value, a brightness value, a contrast value, a color value, or a display angle value.

4. The DPF as described in claim 2, further comprising an input unit configured for receiving user input.

5. The DPF as described in claim 4, wherein the selected picture is one of pictures selected by a user via the input unit and displayed by the DPF.

6. A method of adjusting picture parameters applied on a digital photo frame (DPF), comprising:
extracting parameter values of a selected picture;
defining the extracted parameter values as standard parameter values; and
adjusting parameter values of other pictures according to the standard parameter values.

7. The method as described in claim 6, further comprising: storing the defined standard parameter values.

8. The method as described in claim 6, wherein in the adjusting parameter values step, the other pictures comprise other pictures to be displayed.

9. The method as described in claim 6, wherein in the adjusting parameter values step, the other pictures comprise other pictures all stored in the DPF.

10. The method as described in claim 6, wherein defining the extracted parameter values step comprises: displaying a prompt to remind a user whether to define the extracted parameter values as the standard parameter values.
